(19) United States
(12) Patent Application Publication
(10) Pub. No.: US 2013/0139078 A1
(43) Pub. Date: May 30, 2013

(54) ELECTRONIC READER AND PAGE PROCESSING METHOD THEREOF

(71) Applicants: CHIA-HAO CHUANG, Tu-Cheng (TW); CHIH-SAN CHIANG, Tu-Cheng (TW); YUAN-YUAN JIANG, Shenzhen City (CN); YAO-HUI ZENG, Shenzhen City (CN); XUE-TAO TAN, Shenzhen City (CN); SHENG-CHU LU, Shenzhen City (CN)

(72) Inventors: CHIA-HAO CHUANG, Tu-Cheng (TW); CHIH-SAN CHIANG, Tu-Cheng (TW); YUAN-YUAN JIANG, Shenzhen City (CN); YAO-HUI ZENG, Shenzhen City (CN); XUE-TAO TAN, Shenzhen City (CN); SHENG-CHU LU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/484,290

(22) Filed: May 31, 2012

(30) Foreign Application Priority Data
Nov. 25, 2011 (CN) 201110380586.5

(51) Int. Cl. G06F 3/048; G06F 3/041

(52) U.S. Cl. 715/764

(57) ABSTRACT

A page processing method for an electronic reader including a touch screen is provided. The method comprising: displaying a page of a selected file on the touch screen in response to a user's operation; detecting a touch on the displayed page, and generating a signal associated therewith; determining whether the touch of the user is an earmark gesture according to the signal; adding an earmark to the displayed page if the touch of the user is an earmark gesture; displaying the earmarked page on the touch screen; gathering all the earmarked pages and generating an index file containing the earmarked pages; and storing the index file. An electronic reader using the page processing method is also provided.

### BACKGROUND

1. Technical Field

The present disclosure relates to electronic readers and page processing methods thereof, and particularly, to an electronic reader with a touch screen and a page processing method thereof.

2. Description of Related Art

Many electronic devices provide text display functions (hereinafter electronic readers), e.g., mobile phones, digital photo frames, and e-book readers, are capable of storing and displaying electronic documents for users to read. During reading, the user may wish to mark pages containing favorite and/or important contents for later/future reviewing. However, the user cannot add marks on each chosen pages and store them for quick retrieval in the future, which is a shortcoming.

Therefore, what is needed is an electronic reader and a page processing method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic reader and a page processing method thereof. Moreover, in the drawings, like reference numerals designate corresponding sections throughout the several views.

FIG. 1 is a block diagram of an electronic reader in accordance with an exemplary embodiment.

FIGS. 2-4 are schematic diagrams showing a plurality of user interfaces of the electronic reader of FIG. 1.

FIG. 5 is a flowchart of a page processing method for electronic readers, such as the one of FIG. 1, in accordance with the exemplary embodiment.

### DETAILED DESCRIPTION

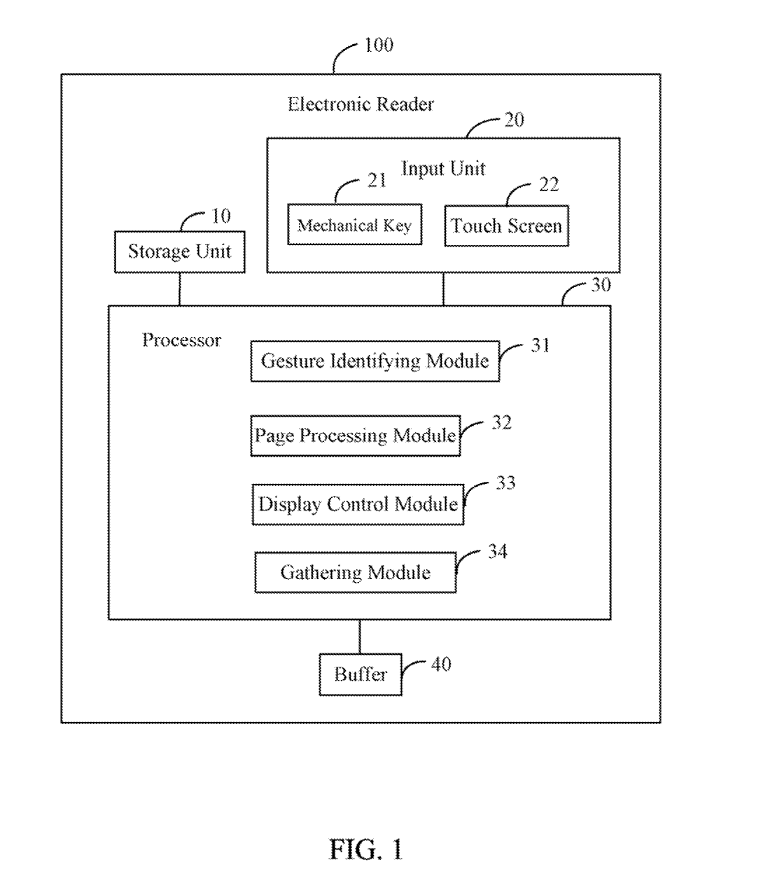

Referring to FIG. 1, an electronic reader 100 is disclosed as an exemplary embodiment. The electronic reader 100 adds an earmark on each of the pages selected by a user in response to the user's operation, and stores the selected pages. The electronic reader 100 is an electronic-book reader. In alternative embodiments, the electronic reader 100 can be other electronic readers with touch screens, such as a mobile phone, a tablet computer, a digital photo frame or the like.

The electronic reader 100 includes a storage unit 10, an input unit 20, and a processor 30. The storage unit 10 stores a number of electronic files.

The input unit 20 is configured for generating signals in response to user inputs. The input unit 20 includes a number of mechanical keys 21 and a touch screen 22. When depressed by the user, the mechanical key 21 generates signals such as operation signals for powering on/off the electronic reader and flipping pages etc. The touch screen 22 generates signals for opening an electronic file, adding earmarks on the displayed page, flipping pages and panning the displayed page etc., in response to the user's touches thereon.

The processor 30 includes a gesture identifying module 31, a page processing module 32, and a display control module 33.

After the electronic reader 100 is powered on and the touch screen 22 displays a page according to the user's operation, the user may touch the touch screen 22. The gesture identifying module 31 determines whether any touch on the touch screen 22 is an earmark gesture according to the signals from the touch screen 22, and, if it is, transmits the result to the page processing module 32. In the embodiment, when the user traces an “L” which begins at one of the vertexes of the four corners of the touch screen 22, and stops at one of the two boundary lines of the touch screen 22 which form the starting vertex, the gesture identifying module 31 determines that the touch operation is an earmark gesture. That is, an earmark gesture is a trace in the shape of an “L” having a starting point at one of the vertexes of the four corners of the touch screen 22 and an end point on one of the two boundary lines together forming the starting vertex.

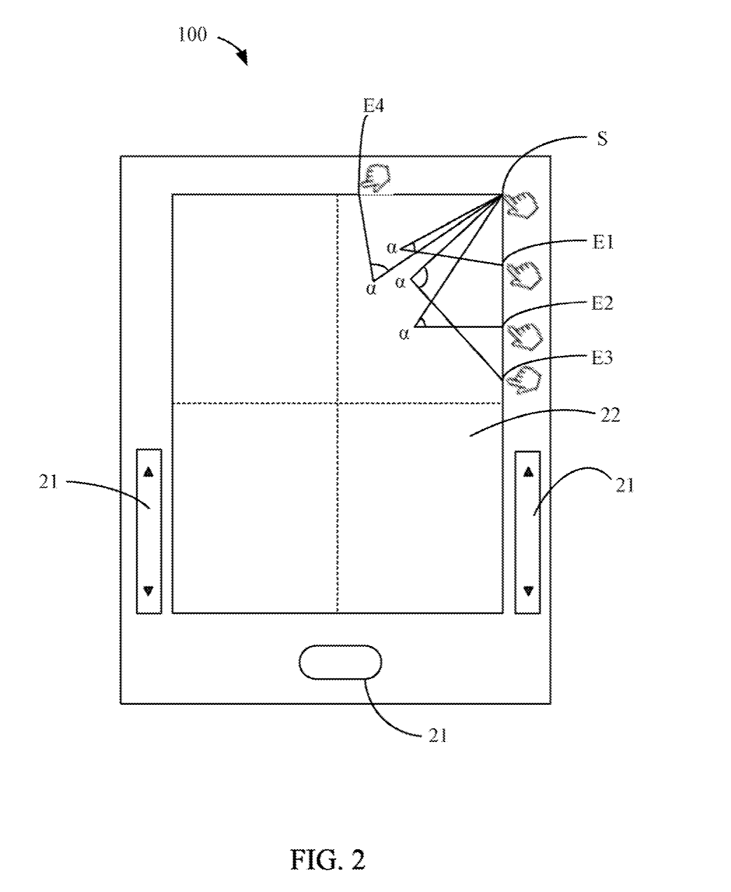

In this embodiment, the end point of the trace “L” can be any point on one of the two boundary lines forming the starting vertex and close to the starting point. FIG. 2 is a schematic diagram, showing the user touch at the starting point S of the upper right corner of the touch screen, and sliding to the ends E1, E2, E3, and E4 to create earmarks. To reduce the possibility of a failure to recognize the earmark operation, in this embodiment, when the angle within the traced “L” falls between the range of 30 degrees and 150 degrees, the gesture identifying module 31 determines that the touch operation is an earmark gesture. In an alternative embodiment, the traced “L” can be determined to be an earmark gesture having any angle less than 180 degrees within the traced letter “L”.

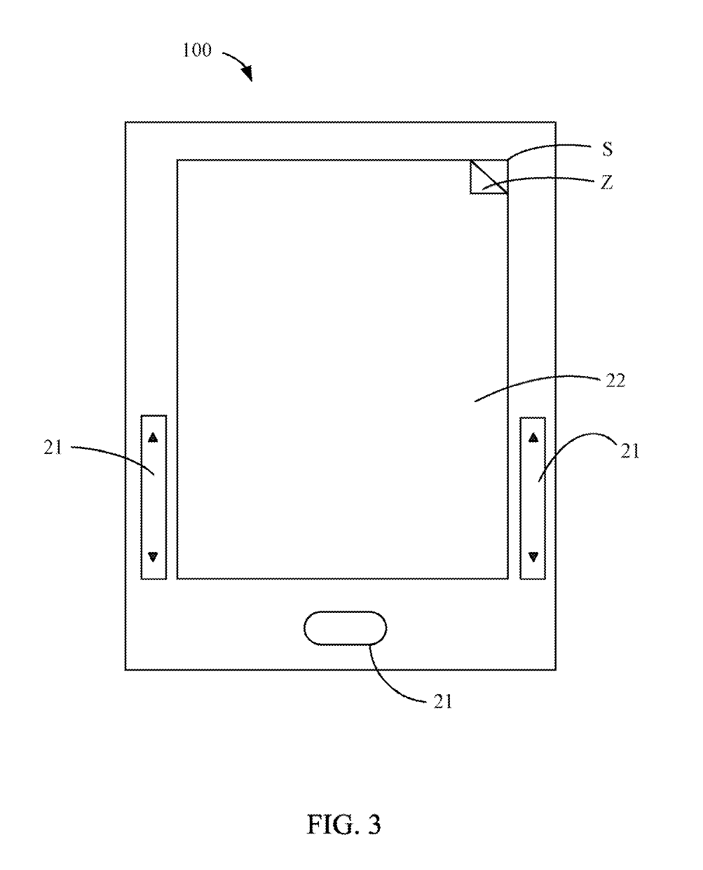

The page processing module 32 is configured to process the displayed page on the touch screen 22 according to the transmission from the gesture identifying module 31. In the embodiment, the page processing module 32 adds an earmark on the displayed page when the gesture identifying module 31 determines that the touch operation of the user is in fact an earmark gesture. As shown in FIG. 3, the earmark added on the displayed page by the page processing module 32 is the shape or symbol of a triangle Z. The triangle Z resembles a folded corner of the displayed page. The triangle Z is shown on the page simulating a real folded corner. In another embodiment, the added earmark is a curved figure simulating a paper flipping effect.

The display control module 33 controls the display of the earmarked page (i.e., the page to which earmark added) on the touch screen 22. Thus, referring to FIG. 3, an earmarked page is vividly displayed to the user.

The electronic reader 100 further includes a buffer 40 configured for temporarily storing all earmarked pages.

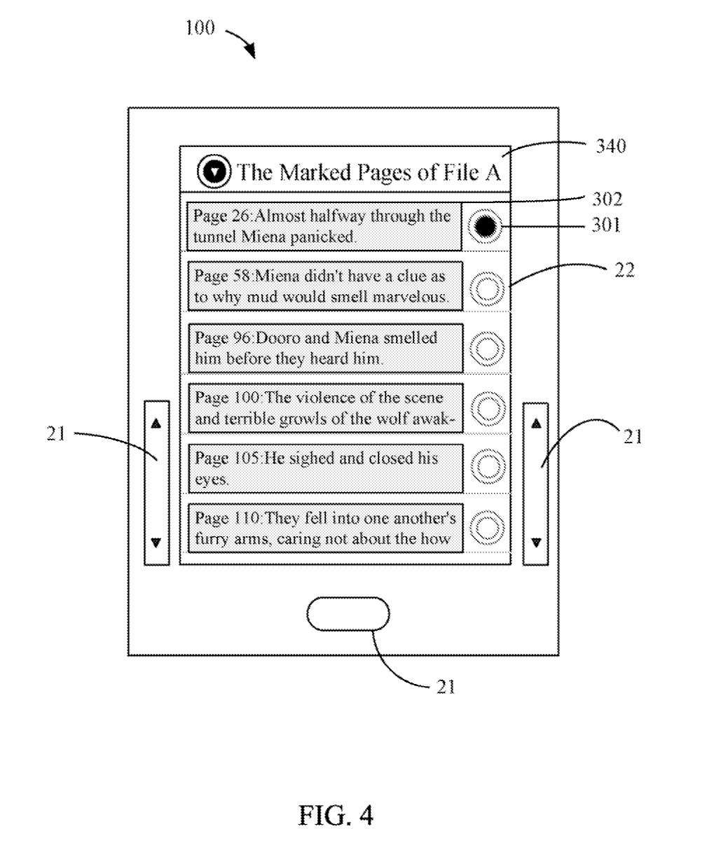

Referring to FIG. 4, the processor 30 further includes a gathering module 34. When the file being read by the user is closed, the gathering module 34 gathers the earmarked pages stored in the buffer 40, generates an index file 340 containing the earmarked pages, and stores the index file 340 in the storage unit 10. In this embodiment, the gathering module 34 retrieves the page number of each earmarked page and retrieves portions of the content of each earmarked page according to a predetermined rule as hereinafter defined, repaginates the retrieved pages according to the page numbers, generates an index file 340 containing the earmarked pages, and stores the index file 340 in the storage unit 10. The predetermined rule hereinbefore mentioned can be retrieving the first sentence/paragraph of each of the earmarked pages, or retrieving the contents of a predetermined number of lines of the earmarked pages, eg lines 2-3.

Referring to FIG. 4, the index file 340 includes the indexes 302 of each of the earmarked pages and a number of icons 301 corresponding to each of the indexes 302. Each of the indexes 302 includes the page number of the earmarked page and the first sentence of the earmarked page.

In this embodiment, the touch screen 22 further generates other signals in response to the touches of the user. The gesture identifying module 31 further identifies the operations of the user according to the generated signals, and the display control module 33 further controls the touch screen 22 to display the content corresponding to the operations identified by the identifying module 31. For example, referring to FIG. 4, when the user wishes to review the earmarked pages, the user accesses the index file 340 of the file A via the touch screen 22. If the user touches the icon for page 26 displayed on the touch screen 22, the gesture identifying module 31 identifies the user's selection operation, then the display control module 33 displays a black spot inside the icon 301. If the user further double-clicks the selected index, the display control module 33 displays the whole of the earmarked page.

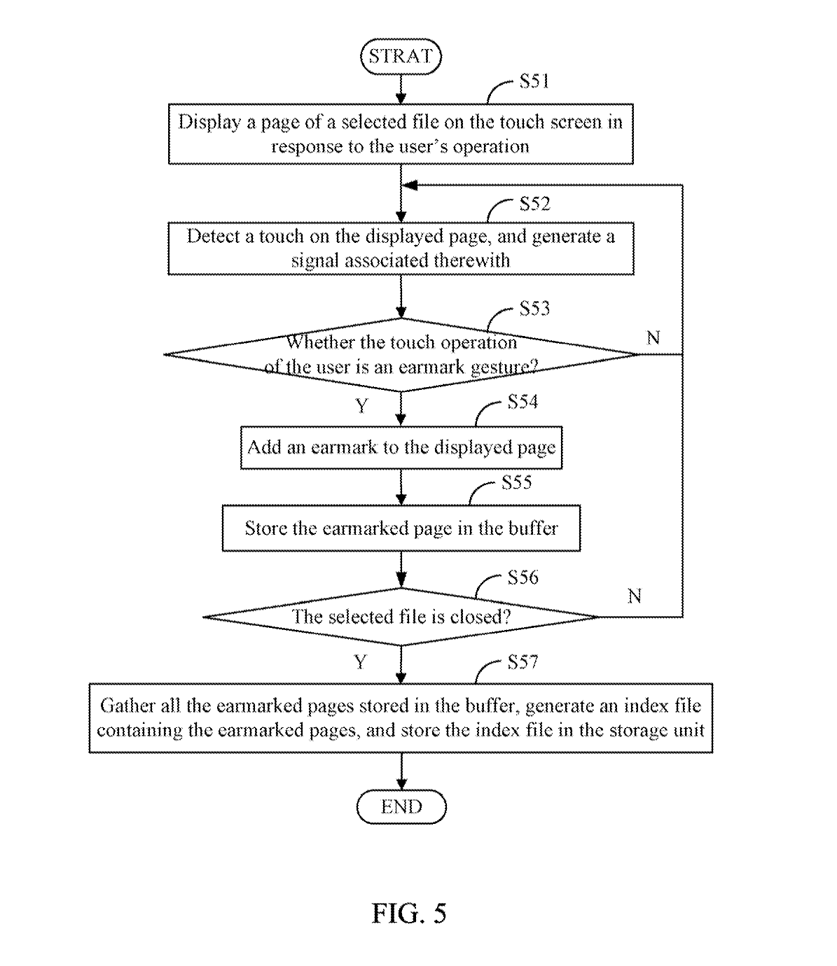

Referring to FIG. 5, a flowchart of a page processing method of the electronic reader 100 of FIG. 1 is shown. The method includes the following steps, each of which is related to the various components contained in the electronic reader 100. First, the user has activated the text display function of the electronic reader 100.

In step S51, the display control module 33 displays a page of a selected file on the touch screen 22 in response to the user's operation.

In step S52, the touch screen 22 detects a touch on the displayed page, and generates a signal associated therewith.

In step S53, the gesture identifying module 31 determines whether the touch operation of the user is an earmark gesture according to the signal, if yes, the process goes to step S54, otherwise, the process goes back to step S52. In the embodiment, when the fingertip of the user traces the shape of the letter “L” on the screen, which begins at one of the vertexes of the four corners of the touch screen 22, and stops at one of the two boundary lines of the touch screen 22 which form the starting vertex, the gesture identifying module 31 determines that the touch operation is an earmark gesture. That is, an earmark gesture is an “L” traced on the touch screen 22 having a starting point at one of the vertexes of the four corners of the touch screen 22 and an ending point on one of the two boundary lines together forming the starting vertex.

In step S54, the page processing module 32 adds an earmark to the displayed page. In this embodiment, the earmark added by the page processing module 32 is represented by a triangle Z. The triangle Z looks like a folded corner of the displayed page. The triangle Z is shown on the page simulating a folded corner of a page. In another embodiment, the added earmark is a curved figure simulating a page flipping effect.

In step S55, the page processing module 32 stores the earmarked page in the buffer 40.

In step S56, the processor 30 determines when the selected file is closed, if yes, the process goes to step S57, the process remains in S52 until the selected file is closed.

In step S57, the gathering module 34 gathers all the earmarked pages stored in the buffer 40, generates an index file 340 containing the earmarked pages, and stores the index file 340 in the storage unit 10. In this embodiment, the gathering module 34 retrieves the page number of each earmarked page and retrieves portions of the content of each earmarked page according to a predetermined rule as hereinafter defined, repaginates the retrieved page numbers and the retrieved content according to the page number, generates an index file 340, and stores the index file 340 in the storage unit 10. The predetermined rule hereinbefore mentioned can be retrieving the first sentence/paragraph of each of the earmarked pages, or retrieving the contents of a predetermined number of lines of the earmarked pages, eg lines 2-3.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A page processing method for an electronic reader with a touch screen, the method comprising:
displaying a page of a selected file on the touch screen in response to a user's operation;
detecting a touch on the displayed page, and generating a signal associated therewith;
determining whether the touch of the user is an earmark gesture according to the signal;
adding an earmark to the displayed page if the touch of the user is an earmark gesture;
displaying the earmarked page on the touch screen;
gathering all the earmarked pages and generating an index file containing the earmarked pages; and
storing the index file.

2. The method as described in claim 1, wherein the earmark gesture is an “L” traced on the touch screen having a starting point at one of the vertexes of the four corners of the touch screen and an ending point on one of the two boundary lines together forming the one of the vertexes.

3. The method as described in claim 2, wherein an angle range within the traced “L” falls between the range of 30 degrees and 150 degrees.

4. The method as described in claim 1, wherein the step of “gathering the earmarked pages, generating an index file containing the earmarked pages” comprises:
retrieving the page numbers of each earmarked page and retrieving portions of content of each earmarked page according to a predetermined rule;
repaginating the retrieved pages according to the retrieved page numbers; and
generating the index file containing the retrieved pages.

5. The method as described in claim 4, wherein the predetermined rule is to retrieve the first sentence or first paragraph of each earmarked page.

6. The method as described in claim 1, wherein the step of “gathering the earmarked pages, generating an index file containing the earmarked pages” comprises:
retrieving the page numbers of each earmarked page and the first sentence of each earmarked page;
repaginating the retrieved page according to the retrieved page numbers; and
generating the index file containing the retrieved pages.

7. The method as described in claim 1, wherein a triangle is shown on the display page to represent the earmark added to the displayed page.

8. The method as described in claim 7, wherein the triangle resembles a folded corner of the displayed page.

9. An electronic reader, comprising:
a touch screen configured for detecting a touch on the displayed page and generating a signal associated therewith; and
a processor comprising:
a gesture identifying module, configured to determine whether the touch of the user is an earmark gesture according to the signal;
a page processing module, configured to add an earmark to the displayed page if the touch of the user is an earmark gesture;
a display control module, configured to control the touch screen to display a page of a selected file on the touch screen in response to a user's operation, and to display the earmarked page on the touch screen; and
a gathering module, configured to gather all the earmarked pages and to generate an index file containing the earmarked pages.

10. The electronic reader as described in claim 9, further comprising a storage unit configured to store all the earmarked pages.

11. The electronic reader as described in claim 9, wherein if the fingertip of the user traces the shape of the letter “L” on the touch screen, which begins at one of the vertexes of the four corners of the touch screen, and stops at one of the two boundary lines of the touch screen which form the starting vertex, the gesture identifying module determines the touch is an earmark gesture.

12. The electronic reader as described in claim 11, wherein an angle within the traced “L” falls between the range of 30 degrees and 150 degrees.

13. The electronic reader as described in claim 9, wherein the page processing module is configured to retrieve the page numbers of each earmarked page and retrieving portions of content of each earmarked page according to a predetermined rule, and repaginate the retrieved pages according to the retrieved page numbers.

14. The electronic reader as described in claim 13, wherein the predetermined rule is to retrieve the first sentence or first paragraph of each earmarked page.

15. The electronic reader as described in claim 9, wherein the page processing module is configured to retrieve the page numbers of each earmarked page and the first sentences of each earmarked page, and repaginate the retrieved pages according to the retrieved page numbers.

16. The electronic reader as described in claim 9, wherein a triangle is shown on the display page to represent the earmark added to the displayed page.

17. The electronic reader as described in claim 16, wherein the triangle resembles a folded corner of the displayed page.

18. The electronic reader as described in claim 9, further comprising a buffer configured to temporarily store all the earmarked page.
